(19) United States
(12) Patent Application Publication
(10) Pub. No.: US 2012/0204113 A1
(43) Pub. Date: Aug. 9, 2012

(54) Automatic Display of Synergized Status Information

(76) Inventors: Daniel Marc Gatan Shiplacoff, Los Altos, CA (US); Lee Brandon Keely, San Francisco, CA (US); Jesse Donaldson, Mountain View, CA (US)

(21) Appl. No.: 13/369,213

(22) Filed: Feb. 8, 2012

Related U.S. Application Data
(60) Provisional application No. 61/441,237, filed on Feb. 9, 2011.

(51) Int. Cl. G06F 3/048; G06F 3/14

(52) U.S. Cl. 715/733; 715/864

(57) ABSTRACT

A system and a method are disclosed for presenting static and dynamic data on a mobile device for a contact responsive to a communication with the contact. When a communication is initiated, a contact is identified based on static information such as an email address or a phone number. Additionally, dynamic data, such as a status message posted on a social networking service associated with contact, or a location of the contact is retrieved from appropriate services or databases in real time. The retrieved dynamic data is displayed on a user interface on the mobile device in substantially real-time, allowing the user to view static and dynamic information about a contact.

### RELATED APPLICATIONS

This application claims priority to U.S. Patent Application No. 61/441,237, filed Feb. 9, 2011, entitled “Automatic Display of Synergized Status Information.” The aforementioned priority application is hereby incorporated by reference for all purposes.

### BACKGROUND

1. Field of Art

The disclosure generally relates to the field of mobile computing, in particular to managing retrieving information associated with a contact using a mobile computing device.

2. Description of the Related Art

Mobile computing devices are becoming increasingly more powerful and functional devices. Many mobile devices are multifunctional devices with multiple device roles, such as personal digital assistant (PDA), smart phone, cellular phone, portable media player, voice recorder, video recorder, global positioning system (GPS), camera and electronic file storage. In order to support this increased functionality, the mobile computing devices generally store and manage contacts and related static information. Such static information includes contact details such as names, addresses, telephone numbers, e-mail addresses, social networking system identifiers and instant messaging identifiers. Typically, the static information is stored on the mobile computing device which can be accessed by the user at anytime while making or receiving a phone call.

However, a user has to retrieve dynamic information from one or several destinations. Dynamic information is any information that is time-sensitive in nature. For example, an instant messaging application, an e-mail application, a social networking system, a weather reporting system or a traffic reporting system may provide dynamic data such as the online availability of the contact, the status message of the contact, etc. Typically a user must access an application executing on a mobile computing device or use a web browser to access and retrieve such dynamic information. However, a user may not know when new updates are made to the dynamic information and may not receive a status update in a timely manner. In other instances, the user may not remember to check or retrieve updated status information.

In the context of contacts in a contact application, when a user seeks to connect to a contact listed in a contacts application, the user is forced to identify and select different types of static data related to the contact to launch one of several separate applications to access dynamic data specific to the selected type of static data. Such an approach is time-consuming and cumbersome especially when the user needs to connect to several contacts which necessitates that the user repeatedly locate each of these contacts in separate applications.

Another drawback to accessing various separate applications for dynamic data specific to the selected type of static data is that the user is forced to switch between multiple presentation views for each contact, one for each type of static data related to the contact and each separate application that is launched to access dynamic data related to the contact. This also is time consuming as well as cumbersome.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIGS. 1a and 1b illustrate one example embodiment of a mobile computing device.

FIG. 2 illustrates one example embodiment of a mobile computing device architecture.

FIG. 3a illustrates one embodiment of a method of rendering static and dynamic data on a user interface of a mobile computing device based on a corresponding data model.

FIG. 3b illustrates one example embodiment of a method of presenting static and dynamic data on a user interface of a mobile computing device.

FIG. 4 illustrates one example embodiment of a method of retrieving static and dynamic data associated with a phone number.

FIG. 5 illustrates one example embodiment of a method of retrieving static and dynamic data responsive to an incoming phone call.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Configuration Overview

One embodiment of a disclosed system, method and computer readable storage medium provides context information for a contact a user seeks to communicate with by combining static and dynamic data corresponding to the contact. The contact includes a data entry (e.g., in a database) accessible by a contact application. For example, the system (and process) can present static data such as a contact name and phone number as well as dynamic data such as the latest status information about that contact. The dynamic data such as the latest status information may be retrieved from the activity undertaken by the contact in a social networking system or from activity derived from a device used by the user, for example, global positioning system (GPS) coordinates on a device having a GPS based services. In one embodiment, the static and dynamic information associated with a contact is presented to the user responsive to an incoming phone call from the contact.

In one embodiment of a configuration for presenting static and dynamic data to a user of a mobile device, a data object corresponding to a contact stored on the mobile device is identified. The data object can have a plurality of fields corresponding to static and dynamic data associated with a contact. The system retrieves dynamic data corresponding to the dynamic fields associated with the object. The dynamic data is retrieved at least in part on the amount of time elapsed since the previous retrieval of the dynamic data. The system simultaneously displays the static and dynamic data associated with an object corresponding to a contact within a user interface of an application executing on the mobile device. Additional details corresponding to the system (and method and computer readable storage medium) are described herein.

### Computing Machine Architecture

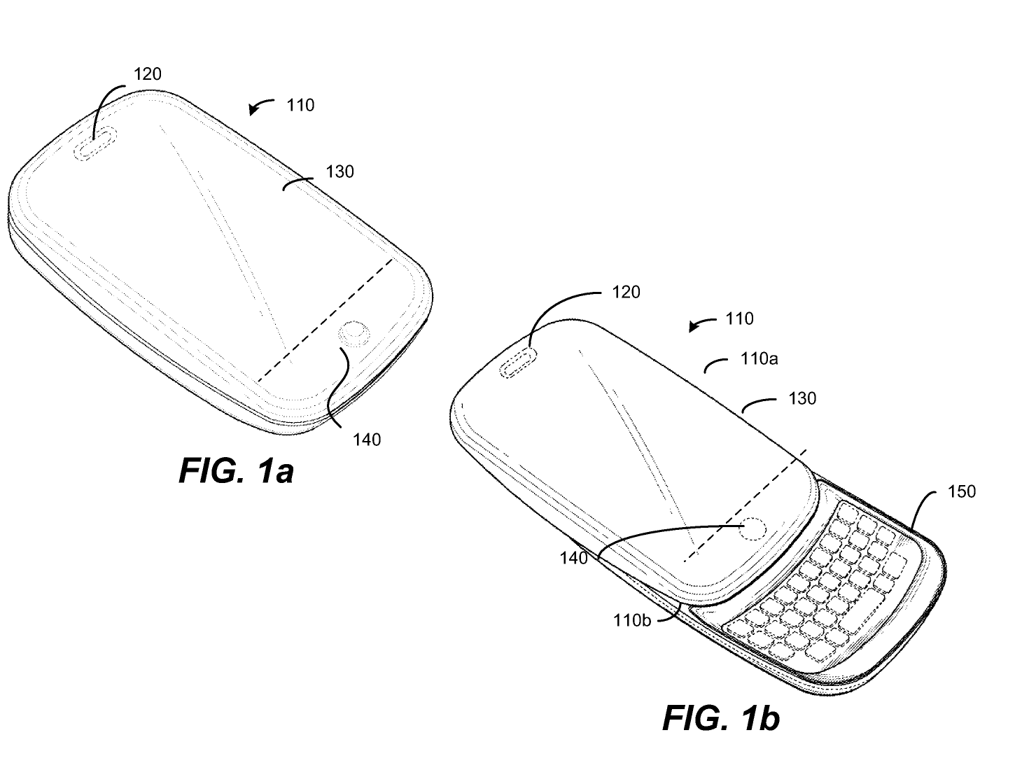

In one example embodiment, the configuration as disclosed may be configured for use between a mobile computing device, that may be a host device, and an accessory device. FIGS. 1a and 1b illustrate one embodiment of a mobile computing device 110. FIG. 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook computer, notebook computer, a tablet (or pad) computer, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., desktop computers, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

In one embodiment, the mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a solid-state based gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A Z E R T Y, or other equivalent set of keys on a keyboard such as a DVORAK keyboard or a double-byte character keyboard). In some embodiments, the keypad may be screen based and there may or may not be a separate physical keypad area 150.

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

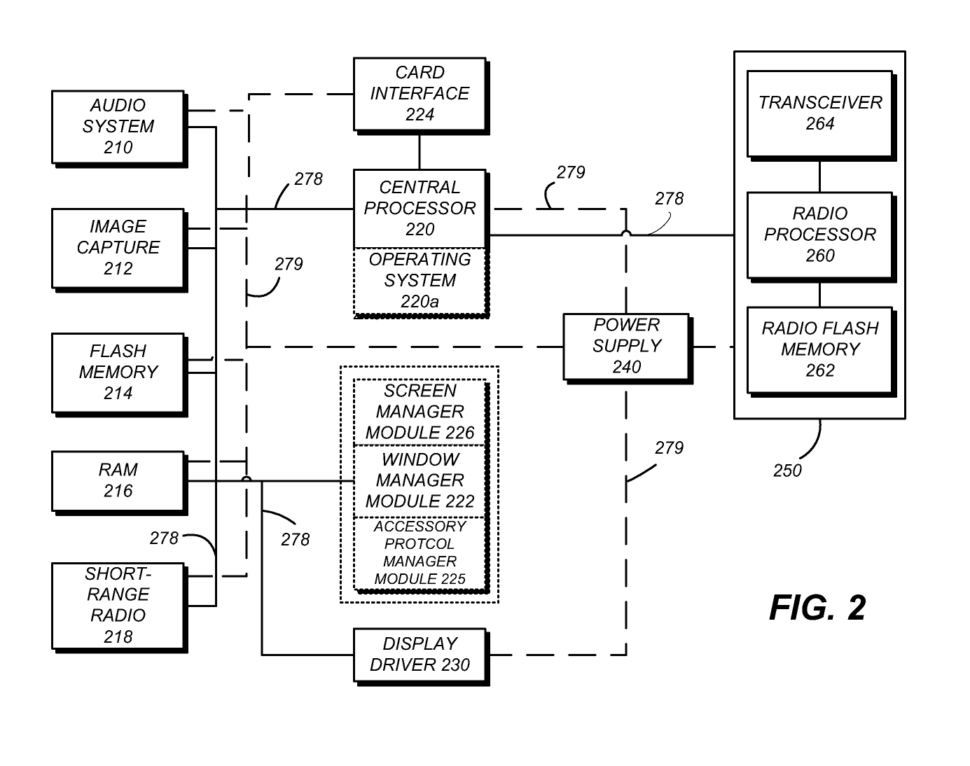

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIGS. 1a and 1b. The mobile computing device 110 includes one or more processors (for ease of discussion referenced as a central processor 220), a power supply 240, and a radio subsystem 250. The central processor 220 is configured for operation with a computer operating system. The operating system is an interface between hardware and an application, with which a user typically interfaces. The operating system is responsible for the management and coordination of activities and the sharing of resources of the mobile computing device 110. The operating system provides a host environment for applications that are run on the mobile computing device 110. As a host, one of the purposes of an operating system is to handle the details of the operation of the mobile computing device 110.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

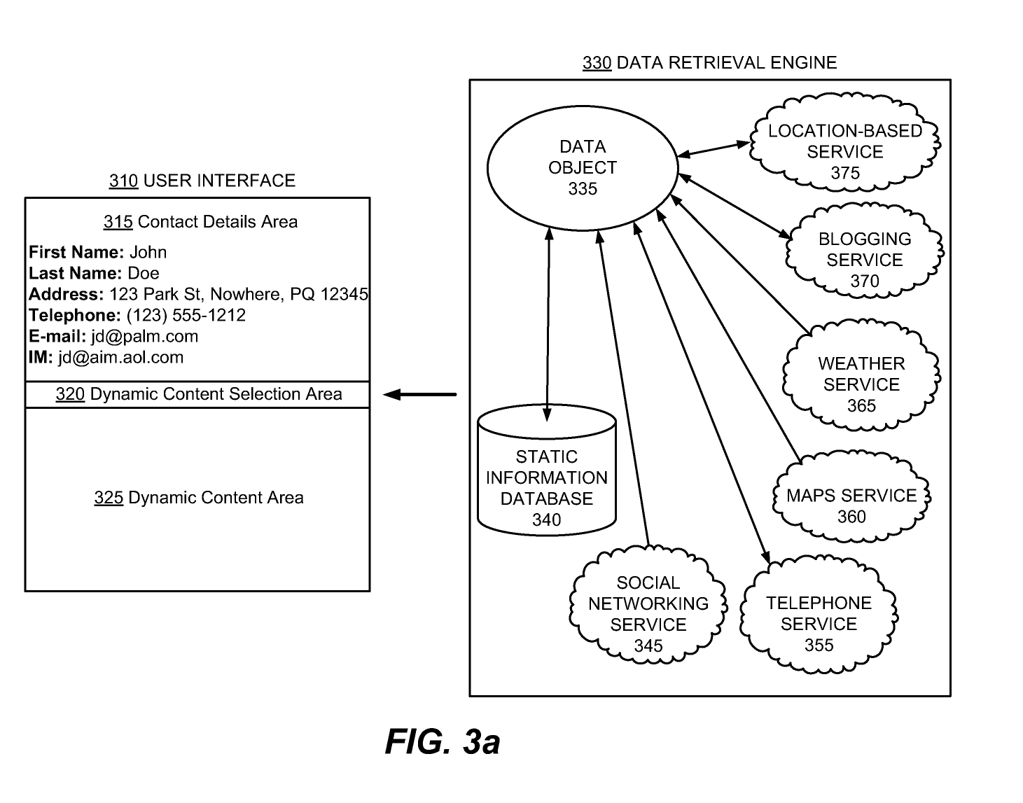

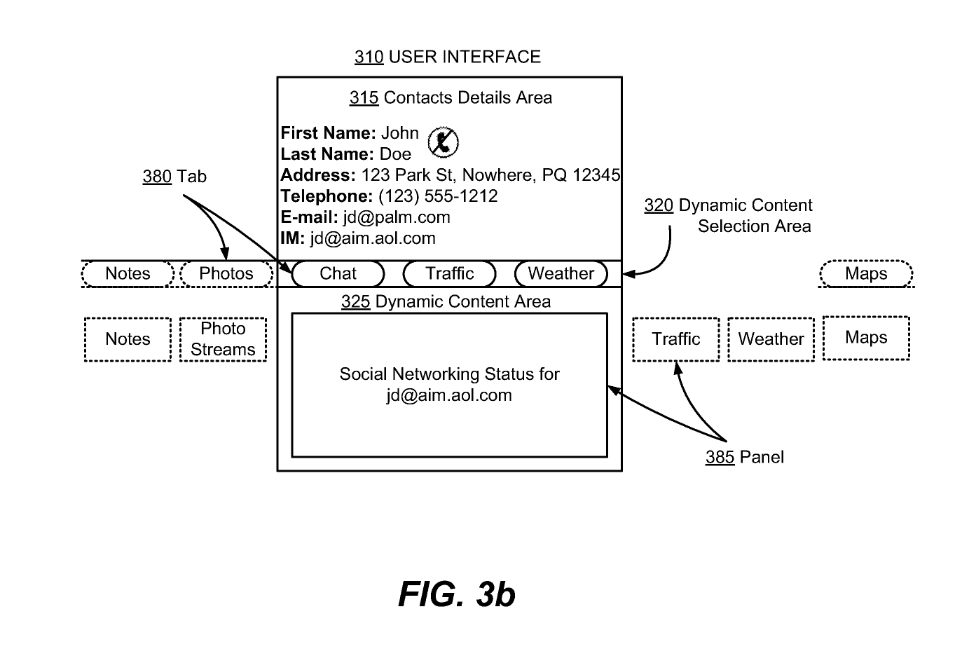

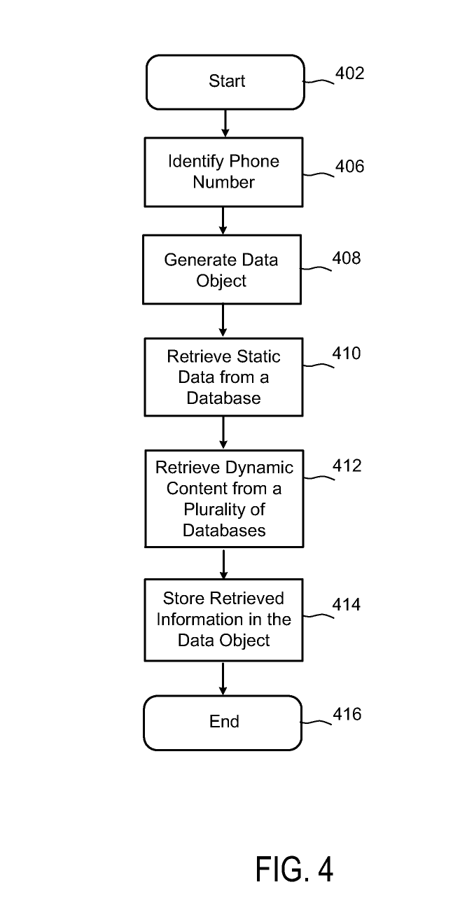

An accessory protocol manager module 225 comprises software that is, for example, integrated with the operating system or configured to be an application operational with the operating system. In some embodiments it may comprise firmware, for example, stored in the flash memory 214. The accessory protocol manager 225 is configured to store the instructions and data corresponding to the processes disclosed herein, for example, with respect to FIGS. 3 and 4. For example, the accessory protocol manager includes the logic for computing and storing checksums within the device 110 as further described herein.

In one embodiment, central processor 220 executes logic (e.g., by way of programming, code, or instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) or higher mobile, Long Term Evolution (LTE), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a serial line 278.

The card interface 224 is adapted to communicate, wireles sly or with a wired interface, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

### Example Data Retrieval and Presentation

FIG. 3a illustrates one embodiment of a method of rendering static and dynamic data on a user interface 310 of the mobile computing device 110 based on a corresponding data retrieval engine 330. In one embodiment, a data retrieval engine 330 retrieves and updates an existing data object 335 for each contact stored on the user's mobile computing device 110 with retrieved dynamic data. In another embodiment, data retrieval engine 330 generates a data object 335 for a contact when a first communication is established with a contact. The data object 335 includes a plurality of fields associated with static and dynamic data. For example, the data object can contain static data fields such as contact name, contact phone number, contact email address etc. This may be information previously entered and stored. Additionally, the data object can also contain dynamic data fields such as status message associated with a social networking system or an instant messaging system, current location, directions to the contact's location, blog entry from a blogging service, etc. This may include data that changes more frequently including ‘real time’ or ‘on the fly’ data. Dynamic data may be ‘pushed’ or ‘pulled’ by the mobile computing device 110. Thus the data object 335 can include static and dynamic data about a contact. As described above, the dynamic data stored in the data object 335 can represent a substantially real-time view based on when the data retrieval engine 330 retrieves dynamic data for the particular contact. For example, the data object 335 can include substantially real-time dynamic data about a contact if the data retrieval engine 330 has recently updated the data object with information from external data databases or sources. The data object is further described with respect to FIGS. 3a, 3b and 4.

The data retrieval engine 330 can execute on the mobile computing device 110 or on a server external to the mobile computing device 110. The data retrieval engine 330 enables a system-wide, mobile, and extensible framework that can plug in new services or applications starting with static contact information to allow streaming of dynamic contact information based on the static information. The extensible framework enables selection of a contact and mining the information related to the contact by accessing various external databases or sources of information relating to the contact. Examples of external sources include, but are not limited to social networking services 345, telephone services 355, maps services 360, weather services 365, blogging services 370, location-based services 375, and the like. The extensible framework allows data to be pushed into a contact's data object 335 so that the data object 335 represents a single hub for information gathering.

In one embodiment, the data retrieval engine 330 retrieves dynamic data from the external sources when a contact's information is requested. For example, when a user of the mobile computing device 110 receives a phone call from a contact, the data retrieval engine 330 can retrieve the contact's dynamic data based on the available static data. The data retrieval engine 330 can retrieve dynamic data based on the type and size of the dynamic data. For example, text data or other smaller data can be retrieved in substantially real-time or responsive to an incoming phone call.

Larger files such as images or videos can retrieved by the data retrieval engine 330 at a periodic interval based on several factors such as the time-sensitivity of the data or the type and speed of communications networks available. In one embodiment, dynamic data can be categorized as time-sensitive or time-insensitive. For example, a contact's online availability in an instant messaging application is time-sensitive in nature because online availability is needed to execute an instant communication with the contact. However, a picture of a contact can be time-insensitive in nature because an updated picture may not be needed to execute a communication with the contact. In one embodiment, if it is determined that the dynamic data corresponding to a contact is time-insensitive in nature, the dynamic data can be saved in a database cache for quick retrieval. In one embodiment, if it is determined that the dynamic data corresponding to an entity is time-sensitive in nature, the dynamic data is retrieved by the data retrieval engine 330 every time a request for the dynamic data is made. The data retrieval engine 330 can also retrieve dynamic data based on the speed and availability of a communications network used to retrieve data from the various services. For example, the data retrieval engine 330 can retrieve large data files such as images when a high-speed network is available such as Wi-Fi or cellular data network protocols such as third generation of cellular wireless standards (3G), fourth generation of cellular wireless standards (4G), 3GPP Long Term Evolution (LTE) or Worldwide Interoperability for Microwave Access (WiMax).

As provided above, the periodic intervals to retrieve dynamic data can also vary. For example, the data retrieval engine can retrieve dynamic data and store it locally during low usage periods or when the mobile computing device 330 is being charged. The data retrieval engine 330 can retrieve dynamic data more frequently for contacts who communicate with the user of the mobile computing device 110 on a frequent basis. For example, if a user communicates with a contact ‘John Doe’ everyday, the data retrieval engine 330 can retrieve dynamic data for John Doe every day or at pre-determined time intervals within a day.

The static information database 340 includes static data for a contact. Static data can include any information about a contact that may not change regularly. For example, static data can include a contact's first name, last name, address, phone number, email address, social networking user name, instant messaging user name, etc. Personal information management applications executing on a mobile computing device 110 can access the static information database 340 to retrieve static data of a contact. For example, a maps application executing on a mobile computing device 110 can retrieve a user's home address from the static information database 340 to compute directions to or from the user's home. Similarly, a calendar application can retrieve the user's email address from the static information database 340 to include in a calendar invitation.

The data retrieval engine 330 retrieves a data object 335 for a contact based on the provided static data. For example, if the mobile computing device receives an incoming phone call from a contact, the data retrieval engine 330 retrieves a data object 335 for the contact. It is noted that the retrieval and update can be in real-time or done via a batch process depending on predefined factors, for example, available bandwidth, size of information to be retrieved and updated, or cost for bandwidth usage. In one embodiment, the data retrieval engine 330 retrieves dynamic data from one or more databases or external sources of information for the contact. Examples of such databases or external sources include, but are not limited to social networking services 345, telephone services 355, maps services 360, weather services 365, blogging services 370, location-based services 375, etc.

External sources of information for a contact can be accessed wherein a user of the mobile computing device 110 provides a login and password information associated with the external data source. For example, if the user provides his or her social networking system sign-in information, the data retrieval engine 330 can access the social networking system and retrieve social networking information of the contact identified in the data object 335. Thus, the data retrieval engine 330 can retrieve current status information, change in relationship status information, change in location information and the like from the social networking system. In another embodiment, dynamic data can be provided by applications executing on the mobile computing device 110. For example, a social networking application executing on the mobile computing device 110 can provide status information updates for one or more contacts stored in the static information database 340. The retrieved information can be added to the data object 335 as new attributes of the data object 335 previously instantiated with static data corresponding to the contact. Similarly, data from other external sources such as telephone services 335, maps service 360, weather service 365, blogging service 370, location-based service 375 and others can be retrieved wherein the user provides sufficient log-in information to access those databases.

In one embodiment, the data object 335 can include substantially real-time dynamic data based on static data that previously existed. The substantially real-time dynamic data is captured to the extent that it is available based on the static data and a communication connection is available and made to the various services that are capable of providing dynamic data to generate a substantially real-time view. Starting with a static view of an entity or a contact in the contact list, a variety of external networks become available to provide a wider dynamic view of the contact by adding dynamic content to the static view. In one embodiment, data object is configured to include static data corresponding to contact details and augmented to incorporate dynamic data associated with the contact.

In one embodiment, an interface engine can generate a user interface to display on a screen 130 of the mobile computing device 110 based on static data and dynamic data stored in the data object 335 associated with the contact. For example, an interface engine can render a user interface 310 that provides a single view of a selected contact. The single representation enables the display of static and dynamic contact information within a single presentation session as opposed to multiple presentation sessions. Once a contact is selected, a data object 335 associated with the contact is retrieved or is created for associating with the contact. The user interface 310 displays a contact details area 315 that contains static data relating to the contact and dynamic content area 325 that displays dynamic data in response to a selection made in a dynamic content selection area 320. For example, the contact details area 315 may show the name and contact information for a contact, e.g., John Doe, and the dynamic content selection area 320 can display dynamic contact based on a user selection in the dynamic contact selection area 320. The user interface 310 is described in greater detail in FIG. 3b.

FIG. 3b illustrates one embodiment of a method of presenting static and dynamic data in a user interface 310 on a screen 130 of a mobile computing device. The user interface 310 displays a contact details area 315 that contains static data relating to the contact and a dynamic content area 325 that displays dynamic data in response to a selection made in the dynamic content selection area 320. In one embodiment, the contact details area 315 is enhanced to display dynamic data corresponding to the contact in addition to the static data corresponding to the contact. For example, FIG. 3b illustrates by means of a telephone symbol next to the name of the contact, John Doe, that the contact is currently not accessible by telephone.

In one embodiment, the tabs 380 in the dynamic content selection area 320 can be inferred from the static and dynamic data. The tabs 380 may not be a one-to-one correspondence to data fields in the contact details area 315 but may be related to the data fields. For example, an address may relate to a maps tab and/or a weather tab, an instant messaging identifier may correspond to a chat tab, and a company domain name may correspond to company information or more specifically to stock information. The user interface 310 enables displaying static and dynamic information all within a single view and session. In one embodiment, the data fields are checked to determine what the tabs will be. In another embodiment, the applications installed in the system determine what the tabs will be. Wherever service agreements exist with application vendors the dynamic content selection area 320 may be prepopulated with tabs. The user's personal view with contact information can have a privacy lock switch so that such dynamic information may be shielded, e.g. for security or privacy reasons. In one embodiment, the user's dynamic content selection area 320 may have extra tabs.

The dynamic content area 325 displays dynamic content on one of many panels 385 that correspond to one of many tabs 380. In one embodiment, the user may select a tab 380 in the dynamic content selection area 320 and cause a corresponding panel 385 to be displayed in the dynamic content area 325. The contacts application may place the tabs and corresponding panels in circular queues such that there is correspondence between the selected tab in the dynamic content selection area 320 and the panel displayed in the dynamic content area 325. In one embodiment, the user may “flick” through the panels using a finger or stylus to cause the corresponding tab 380 to be selected and displayed in the dynamic content selection area 320. In one embodiment, the contacts application infers the dynamic content of the panels 385 from the static data in the contact details area 315. The panels 385 may display dynamic data such as the contact's most recent social networking status message, a change in personal information selected within a social networking system, such as a change in marital status, current location of the user, a historic communications log between the user and the contact, a map showing directions to the contact's location or an upcoming meeting location, etc.

The user interface 310 represents a centralized contact dashboard for the mobile computing device 110 with a rich presentation of static and dynamic data. The panels 385 in the dynamic content area 325 are created based on static data fields that are present within the contact details area 315. Each panel corresponds to at least one of the data fields. Navigation between the panels 385 is done either by a gesture or motion or through some other form of user interface interaction through a device or touch screen. In one embodiment, selection of a particular data entry within the contact details area 315 causes a corresponding panel 385 to become active so that the user may act on the dynamic content provided in the panel 385.

In an alternative embodiment, a photo application may be organized such that the contact details area 315 may contain static data fields such as the user's address and/or location and additional dynamic data such as photos related to the user's location and/or address may be displayed in panels 385 in the dynamic content area 325. In one embodiment, panels 385 and tabs 380 are present all within the same presentation view without leaving the view. The single presentation view allows for a single look and feel.

In one embodiment, the user may have personal notes on each contact which may be mined for additional dynamic data by invoking additional services or applications that add the dynamic data to the same view based on static data present in the notes.

FIG. 4 illustrates one embodiment of a method of generating a data object comprising dynamic and static data. To initiate 402 the process, a contact phone number stored on the mobile device 406 is identified 406. In another embodiment, other contact information stored on the mobile device can be identified 406. For example, a name or an email address associated with a contact and stored on the mobile computing device 110 can be identified. In one embodiment, the process identifies 406 such contact information for all contacts stored on the mobile computing device 110. In yet another embodiment, the process identifies 406 a phone number or contact information for a contact entity responsive to receiving or sending a communication to the contact entity. As described in the specification, the communication can include but is not limited to incoming or outgoing phone calls, email messages, SMS messages, MMS message, etc.

In one embodiment, the process generates 408 a data object corresponding to the identified 406 contact information stored on the mobile device. As described in greater detail in reference to FIGS. 3a and 3b, the data object has a plurality of fields for static and dynamic data associated with a contact. For example, the static fields can include items such as name, phone number, email address, home address etc. Dynamic fields can include items such as social networking status information provided by the contact, life-change events associated with the contact as indicated within the social networking system, for example, a change in marital status or change in number of children etc.

In one embodiment, the process retrieves 410 static data from a database on the mobile device. For example, a database residing on the mobile device can include an address book or calendar entries, wherein the process can retrieve 410 static information as provided by static fields in the generated data object. In another instance, the database is stored locally and associated with the mobile device. For example, the address book or the user calendar can be stored in a memory card inserted into the mobile computing device 110 or stored in a network cloud and pulled by or pushed to the mobile computing device 110.

In one embodiment, the process retrieves 412 dynamic content from a plurality of databases. For example, the process can retrieve 412 the status information associated with the contact from a social networking system. In one embodiment, the status information can be retrieved 414 by accessing the social networking system through an application executing on the mobile computing device 110. In another embodiment, the status information can be continually pushed to the mobile computing device 110. In such an embodiment, the process can accept the pushed dynamic data at a particular period of time or when a communication is initiated between the user and the contact.

The process stores 414 the retrieved static and dynamic information in the data object. In one embodiment, the data object is stored on a server, external to the mobile device. In such an embodiment, the process 414 stores the static data retrieved from the mobile device and stores 414 dynamic data retrieved from the various databases and services. This portion of the process ends 416 once the data is retrieved.

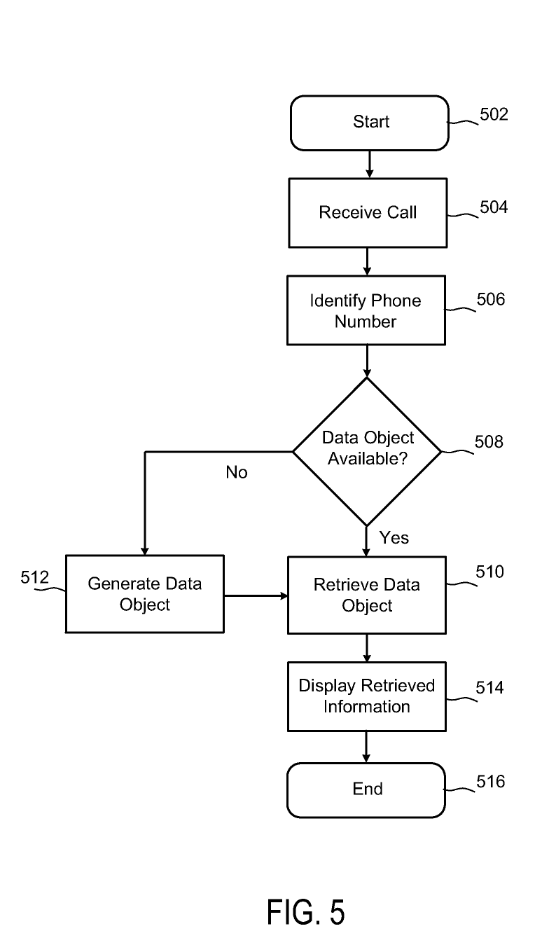

FIG. 5 illustrates one embodiment of a method of presenting static and dynamic data responsive to an incoming phone call. In other embodiments, the process starts 502 responsive to receiving or sending any type of communication with a contact entry. Other types of communication include but are not limited to incoming or outgoing phone calls, email messages, SMS messages, MMS messages, etc. In one embodiment, the process starts 502 once a phone call is received 504 on a mobile device. Responsive to the phone call, the process identifies 506 a phone number associated with the received 504 phone call. In other embodiments, the process can identify a phone number associated with an incoming or outgoing phone call, SMS message, MMS message or an email address associated with an incoming or outgoing email message. The process determines if a data object 335 is available 508 for the identified 506 phone number. If a data object is available for the identified phone number, the process retrieves 510 the data object. In another embodiment, the data object for the identified 506 phone number may be cached in the mobile device. In such an embodiment, the process retrieves the data object from the mobile computing device 110. Additionally, in such an instance, the process retrieves an updated data object from a database external to the data if the data object has been updated subsequent to being cached in the mobile computing device 110. If a data object is not available for the identified phone number, the process generates 512 a data object. The process of generating a data object was previously described, for example, with reference to FIG. 4 above. Once a data object is retrieved 510 the process displays the static and dynamic information associated with the data object, for example, as discussed with greater detail in reference to FIGS. 3a and 3b.

The configurations as describe provide numerous benefits. For example, the user interface 310 displays static data and interaction with the static data to add dynamic data is enabled within the same view or presentation as opposed to jumping to another view to access the dynamic information. The user interface 310 thus allows a contact centric view of data and services all in one place because it enables a single view of the address card that simultaneously displays static and dynamic data. Additionally, a user viewing static and dynamic data for a contact can immediately gain context for a communication, allowing the user to respond appropriately to the contact. For example, if the dynamic data field provides that the contact recently changed his or her marital status from singe to married, the user can view the information and communicate appropriately with the contact. Similarly, the user can also quickly glean important information about the contact, such as any upcoming meetings with the user, weather information at the contact's location, updates photos etc. The configuration thus accesses and provides relevant contact information in substantially real-time view when the user is about to communicate with the contact.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Hardware modules are a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for retrieving and displaying static and dynamic information associated with a contact through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for a mobile computing device, the method being performed by one or more processors and comprising:
retrieving a data object associated with a contact entry, the data object having a plurality of fields associated with static data and dynamic data, wherein the one or more fields for the static data is populated with data from the contact entry;
obtaining dynamic data corresponding to one or more fields of the data object (i) in response to an interaction with the contact entry, and (ii) based, at least in part, on time elapsed since a previous time the dynamic data was obtained; and
generating a user interface to display the static and dynamic data associated with the data object for the contact entry.

2. The method of claim 1, wherein the data object is stored in a memory of the mobile computing device.

3. The method of claim 1, wherein the plurality of fields associated with the data object includes at least one of a name, a phone number, an email address, a home or work location, a current location, a photo, recent social networking content, upcoming events, or a previous time and type of communication with the contact entry.

4. The method of claim 1, wherein the static data comprises data stored in a memory of the mobile computing device, the static data including at least one of a phone number, a name, a photo, or an email address associated with the contact entry.

5. The method of claim 1, wherein the dynamic data comprises data from a source external to the mobile computing device, the dynamic data including at least one of recent social networking content of a contact associated with the contact entry, recent status messages, location of the contact, or upcoming events associated with the contact.

6. The method of claim 1, wherein dynamic data is obtained from at least one database of webpages or services offered on a data network.

7. The method of claim 6, wherein the webpages or services offered on the data network comprises at least one of a social networking system, a maps service, a weather service, a blogging service, a location based service, a calendar based service, or an image hosting service.

8. The method of claim 1, wherein the dynamic data is obtained periodically at a time corresponding to a lowest historical usage rate of the mobile computing device.

9. The method of claim 1, wherein the dynamic data is obtained more frequently for contact entries communicating more frequently with the user of the mobile computing device.

10. The method of claim 1, wherein a frequency of obtaining dynamic data corresponds to at least one of a data type, data size, or a speed of network connection.

11. The method of claim 1, wherein the dynamic data is obtained in response to an incoming communication or an outgoing communication with the contact entry.

12. The method of claim 1, further comprising creating a new data object associated with the contact entry in response to determining that the data object associated with the contact entry does not exist or cannot be identified.

13. The method of claim 1, wherein the interaction with the contact entry includes at least one of requesting information about the contact entry, receiving communication from a contact associated with the contact entry, sending communication to the contact, or retrieving historical communication information associated with the contact entry.

14. A mobile computing device comprising:
a display;
an input mechanism; and
one or more processors coupled to the display and the input mechanism, the one or more processors configured to:
retrieve a data object associated with a contact entry, the data object having a plurality of fields associated with static data and dynamic data, wherein the one or more fields for the static data is populated with data from the contact entry;
obtain dynamic data corresponding to one or more fields of the data object (i) in response to an interaction with the contact entry, and (ii) based, at least in part, on time elapsed since a previous time the dynamic data was obtained; and
generate a user interface to display the static and dynamic data associated with the data object for the contact entry.

15. A non-transitory computer readable medium configured to store instructions, the instructions, when executed by a processor, cause the processor to:
retrieve a data object associated with a contact entry, the data object having a plurality of fields associated with static data and dynamic data, wherein the one or more fields for the static data is populated with data from the contact entry;
obtain dynamic data corresponding to one or more fields of the data object (i) in response to an interaction with the contact entry, and (ii) based, at least in part, on time elapsed since a previous time the dynamic data was obtained; and
generate a user interface to display the static and dynamic data associated with the data object for the contact entry.
